(19) United States
(12) Patent Application Publication
(10) Pub. No.: US 2009/0017203 A1
(43) Pub. Date: Jan. 15, 2009

(54) METHOD FOR PRODUCING OPTICAL FILM

(75) Inventors: Kazuya Hada, Osaka (JP); Ikuo Kawamoto, Osaka (JP); Hideyuki Yonezawa, Osaka (JP); Takashi Kamijou, Osaka (JP); Seiji Umemoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 11/814,744

(22) PCT Filed: Jan. 24, 2006
(86) PCT No.: PCT/JP2006/301055

§ 371 Date: Sep. 16, 2008

(30) Foreign Application Priority Data
Jan. 25, 2005 (JP) 2005-016740

(51) Int. Cl. B05D 3/12; B05D 5/00

(52) U.S. Cl. 427/162

(57) ABSTRACT

This invention provides a method for producing an optical film, the method comprising a rubbing treatment step of rubbing the surface of a lengthy plastic film F with a rubbing roll 4 obtained by winding a raised fabric 4a, an application step of applying a liquid crystalline molecule to the surface of the plastic film processed through said rubbing treatment step and a fixing step of fixing said applied liquid crystalline molecule. In the rubbing treatment step, the lengthy plastic film is supported and conveyed by a conveyer belt 3 having a metal surface, and plural backup rolls 5 which support the underside of the conveyer belt supporting the plastic film are disposed opposite to said rubbing roll, to set a rubbing strength RS defined by the following equation (1) to 2600 mm or more (more preferably 3400 mm or more).

### TECHNICAL FIELD

The present invention relates to a method for producing an optical film used for optical compensation and antireflection in a liquid crystal display device and the like, and particularly, to a method for producing an optical film having uniform optical characteristics at low costs.

### BACKGROUND ART

Various optical elements produced by applying a liquid crystal material to the surface of a base material and by orientating the liquid crystal have been known. In a process of manufacturing such optical elements, rubbing treatment in which the surface of the base material is rubbed in one direction with a raised fabric is usually carried out to orientate the liquid crystal material on the surface of the base material. When the optical element is, for example, a liquid crystal cell, a glass substrate which is the base material is subjected to rubbing treatment as a unit. However, in the case of an optical element (optical film) using a plastic film as the base material, it is more overwhelmingly advantageous in production efficiency and hence from the economical point of view to carry out rubbing treatment continuously in a so-called roll-to-roll system using a lengthy plastic film than to carry out rubbing treatment using a cut film as a unit.

Therefore, various methods have been previously proposed as the method of continuously rubbing a lengthy film by the foregoing roll-to-roll system in the production of an optical film.

In, for example, the publication of JP-A No. 2004-170454, there is a proposal concerning a rubbing method in which a lengthy film is conveyed by a conveyer belt with a metal surface having a mirror finish and at the same time, the surface of the film is rubbed with a rubbing roll disposed over the conveyer belt.

In the publication of JP-A No. 6-110059, there is also a proposal concerning a rubbing method in which the surface of a lengthy film is rubbed with a rubbing roll with continuously conveying the lengthy film between the rubbing roll and a backup roll disposed opposite to the rubbing roll.

When an optical film is produced, in the meantime, a material having a straight-chain structure, for example, a triacetyl cellulose (TAC) film or polyvinyl alcohol (PVA) film is generally used as a base material to be subjected to rubbing treatment. Also, a liquid crystalline molecule having one or more functional groups is used as a liquid crystal material to be applied to a base material (film) which has been subjected to rubbing treatment. Then, the liquid crystalline molecule is solubilized using an appropriate organic solvent, applied to the surface of the rubbed film, followed by drying and orientating and exposed to proper ultraviolet light to crosslink the molecule, thereby fixing the liquid crystalline molecule, to manufacture an optical film.

### DISCLOSURE OF THE INVENTION

However, in the case where using a lengthy TAC film as a base material, rubbing treatment is continuously carried out by a roll-to-roll system, this may be a cause of the blocking (a phenomenon that base materials are stuck among them without the presence of an optical interface) of the base material put into a state wound around a roll prior to the rubbing treatment.

In base materials such as those mentioned above, the surface condition of the blocked part is changed. Therefore, there is the problem that even if the base material is rubbed, the blocked part differs in orientation properties from the other part, so that domains arise in the liquid crystalline molecule and there is therefore the case where uniform orientation state cannot be obtained. When an optical film to be produced is, for example, a retardation film used in a liquid crystal display, uniformity in an image display is important and therefore, a retardation film like the above one in which liquid crystalline molecules are oriented ununiformly has almost no product value.

In order to obtain uniform orientation characteristics in blocked base materials, there is an idea of increasing the pushing amount of the rubbing roll in, for example, the method described in the publication of JP-A No. 2004-170454. However, neither disclosure nor suggestion is found as to the pushing amount to be increased in the publication of JP-A No 2004-170454. Also, there is the problem that if the pushing amount is made to be excessively large, the rubbing treatment cannot be carried out in a stable condition because of, for example, the influence of a loosened conveyer belt.

It is considered to be possible that a blocked base material is made to have uniform orientation characteristics by increasing the pushing amount of a rubbing roll in the method described in the publication of JP-A 6-110059. However, neither disclosure nor suggestion is found as to the pushing amount to be increased in the publication of JP-A No. 6-110059. Also, this method is not practical because it is required to install the rubbing roll and backup roll with high positional accuracy in order to increase the pushing amount and carry out rubbing treatment in a stable condition.

The present invention has been made to solve the prior art problems and it is an object of the present invention to provide a method for producing an optical film having uniform optical characteristics at low costs even in the case of using a base material giving rise to blocking.

The inventors of the present invention have made earnest studies to solve the above problem and as a result, found that (1) rubbing treatment can be carried out in a stable condition by disposing plural backup rolls supporting the underside of a conveyer belt that supports and conveys a lengthy plastic film as a base material even if the pushing amount of a rubbing roll is increased, and that (2) uniform orientation characteristics can be obtained by setting the value of a parameter called “rubbing strength” to a specified value or more even if the blocking of a plastic film has been caused. Thus, the present invention has been completed.

Accordingly, the present invention provides a method for producing an optical film, the method comprising a rubbing treatment step of rubbing the surface of a lengthy plastic film with a rubbing roll obtained by winding a raised fabric, an application step of applying a liquid crystalline molecule to the surface of the plastic film processed through the rubbing treatment step and a fixing step of fixing the applied liquid crystalline molecule, wherein in the rubbing treatment step, the lengthy plastic film is supported and conveyed by a conveyer belt having a metal surface, and plural backup rolls which support the underside of the conveyer belt supporting the plastic film are disposed opposite to the rubbing roll, to set a rubbing strength RS defined by the following equation (1) to 2600 mm or more (more preferably 3400 mm or more).

RS=N·M(1+2πr·nr/v) (1)

Here, N represents the number of rubbings (the number of rubbing rolls) (dimensionless number), M represents the pushing amount of the rubbing roll (mm), π represents the ratio of circumference, r represents the radius (mm) of the rubbing roll (including a raised fabric), nr represents the number of rotations (rpm) of the rubbing roll and v represents a conveying speed (mm/min) of the plastic film.

According to the present invention, a lengthy plastic film can be rubbed continuously by a roll-to-roll system, and therefore, this method can treat the plastic film at low costs, can impart uniform orientation characteristics to the plastic film and hence enables the production of an optical film having uniform optical characteristics. The term “pushing amount of the rubbing roll” means the shift (positional variation) of the rubbing roll pushed to the plastic film from the original position provided that when the position of the rubbing roll is varied with respect to the surface of the plastic film, the position at which the hair tip of the raised fabric wound around the rubbing roll is first brought into contact with the surface of the plastic film is the original position (0 point).

Also, the inventors of the present invention have made earnest studies and as a result, found the following phenomena (A) and (B).

(A) In the rubbing treatment, plural bar-like backup rolls supporting the underside of the conveyer belt which supports and conveys a lengthy plastic film as a base material are arranged in parallel to each other, whereby the flatness of the conveyer belt supported by the backup roll tends to be improved.

(B) In the above (A), it is necessary to decrease the outside diameter of the backup roll inevitably when the interval between the axes of adjacent backup rolls is set to 50 mm or less. In this case, if the conveying speed of the plastic film is fixed, the backup roll resultantly rotates at a higher speed than in the case where the outside diameter of the backup roll is larger in the rubbing treatment. There is therefore a fear that, for example, the plastic film supported by the conveyer belt is deformed by the heat generated at this time. When the interval between the axes of adjacent backup rolls is set to 90 mm or more, on the other hand, the flatness of the conveyer belt is decreased, thereby posing the problem that uneven orientation is caused, leading to easy occurrence of defects of appearance. Therefore, in order to avoid the foregoing problem, the interval between the axes of adjacent backup rolls is set to preferably 50 mm or more and 90 mm or less and more preferably 60 mm or more and 80 mm or less.

Specifically, the plural backup rolls are preferably plural bar-like backup rolls disposed in parallel to each other, wherein the interval between the axes of adjacent backup rolls is set to 50 mm or more and 90 mm or less (preferably 60 mm or more and 80 mm or less).

Such a preferable structure enables the plastic film to be provided with more uniform orientation characteristics, with the result that an optical film having more uniform optical characteristics can be produced.

When the outside diameter (diameter) of the backup roll is set to 30 mm or less, if the conveying speed of the plastic film is fixed, the backup roll resultantly rotates at a higher speed than in the case where the outside diameter of the backup roll is larger in the rubbing treatment. There is therefore a fear that, for example, the plastic film supported by the conveyer belt is deformed by the heat generated at this time. When the outside diameter of the backup roll is set to 80 mm or more, on the other hand, the flatness of the conveyer belt is decreased, thereby posing the problem that uneven orientation is caused, leading to easy occurrence of defects of appearance.

Therefore, the outside diameter of the backup roll is set to preferably 30 mm or more and 80 mm or less (more preferably 40 mm or more and 70 mm or less).

The production method according to the present invention is particularly effective when the plastic film is a triacetyl cellulose film.

Also, the above triacetyl cellulose film is preferably saponified.

If the triacetyl cellulose film is saponified, this can prevent the occurrence of the phenomenon (blocking) that a layer of liquid crystalline molecules fixed to the surface of the triacetyl cellulose film is broken when the optical film produced by the production method according to the present invention is wound roll-wise.

Also, as the above raised fabric, any one of, for example, rayon, cotton and mixtures of these materials is preferably used.

Moreover, the thickness of the above conveyer belt is preferably 0.5 mm to 2.0 mm (more preferably 0.7 to 1.5 mm) not only to prevent the belt from loosing easily but also to impart flexibility to the belt.

The method for producing an optical film according to the present invention makes it possible to produce an optical film having uniform optical characteristics at low costs.

### BRIEF DESCRIPTION OF THE DRAWINGS

FIG. 1 is a perspective view showing the outline of the structure of a rubbing treatment apparatus to carry out a rubbing treatment step in a method for producing an optical film according to an embodiment of the present invention.

FIG. 2 is a front view partially showing the rubbing treatment apparatus shown in FIG. 1, wherein FIG. 2(a) is a front view of the vicinity of a rubbing roll and FIG. 2(b) is an enlarged front view showing the vicinity of contact places of a rubbing roll with the surface of a plastic film.

FIG. 3 is a visual photograph of another example of a backup roll of the rubbing treatment apparatus shown in FIG. 1.

FIG. 4 shows an example of a visual photograph of a retardation film produced in each of the examples and comparative examples of the present invention.

FIG. 5 shows another example of a visual photograph of a retardation film produced in each of the examples and comparative examples of the present invention.

FIG. 6 shows an example of a visual photograph of a triacetyl cellulose film which has been subjected to rubbing treatment in the examples of the present invention.

### BEST MODE FOR CARRYING OUT THE INVENTION

An embodiment of the present invention will be explained with reference to the appended drawings.

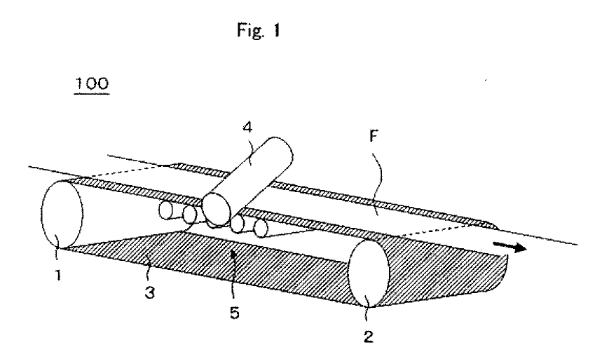

FIG. 1 is a perspective view showing the outline of the structure of a rubbing treatment apparatus to carry out a rubbing treatment step in a method for producing an optical film according to the embodiment of the present invention. As shown in FIG. 1, a rubbing treatment apparatus 100 according to this embodiment is provided with a drive rolls 1 and 2, an endless conveyer belt 3 which is laid across drive rolls 1 and 2 and supports and conveys a lengthy plastic film F, a rubbing roll 4 which is disposed in such a manner as to be vertically movable on the upper part of the conveyer belt 3 and plural (five in this embodiment) bar-like backup rolls 5 which support the underside of the conveyer belt 3 supporting the plastic film F, and are disposed opposite to the rubbing roll 4. In this case, an adequate static eliminator, dust-proofing device or the like may be installed according to the need before and after the rubbing treatment apparatus 100.

The conveyer belt 3 is so designed that the surface on the side supporting the plastic film F is a metal surface (the entire conveyer belt 3 may be made of a metal) having a mirror finish. As such a metal, stainless steel is preferably used from the viewpoint of strength, hardness and durability though various metal materials such as copper and steel may be used. As to the level of mirror finish, the surface roughness (Ra) of the metal surface is designed to be preferably 0.02 μm or less and more preferably 0.01 μm or less in order to secure adhesion to the plastic film F. In order to prevent the plastic film F from loosing, it is necessary to prevent the loosening of the conveyer belt 3 supporting the plastic film F. The thickness of the conveyer belt 3 is preferably 0.5 mm to 2.0 mm and more preferably 0.7 mm to 1.5 mm with the view of the necessity for preventing the conveyer belt 3 from loosing and the necessity for imparting flexibility to some extent to the conveyer belt 3 to lay the belt across the drive rolls 1 and 2. Also, tensile strength imparted to the conveyer belt 3 is preferably 0.5 to 20 kg weight/mm² and more preferably 2 to 15 kg weight/mm² to prevent the conveyer belt 3 from loosing and in consideration of the tensile strength of the conveyer belt 3.

The rubbing roll 4 is provided with a raised fabric wound around its outside periphery. The material and shape of the raised fabric may be appropriately selected corresponding to the material of the plastic film F to be subjected to rubbing treatment. Generally, rayon, cotton or a mixture of these materials may be applied as the raised fabric. The rubbing roll 4 according to the present invention is structured such that its rotation axis can be slanted (for example, an angle of inclination: 0° to 45°) from the direction at a right angle with respect to the conveying direction of the plastic film F (direction shown by the arrow in FIG. 1), and specifically, such that the rotation axis forms a desired axial angle with respect to the long side of the plastic film F. Also, the direction of the rotation of the rubbing roll 4 may be appropriately selected corresponding to the condition of the rubbing treatment.

The plural backup rolls 5 are arranged such that they support the underside of the conveyer belt 3 supporting the plastic film F and are opposite to the rubbing roll 4, as described above. When these plural backup rolls 5 are arranged in such a manner, the rubbing treatment can be carried out stably even if the rubbing roll is pushed in the condition that its axis of rotation is slanted or even if the pushing amount of the rubbing roll 4 is large.

When the plastic film F is subjected to rubbing treatment using the rubbing apparatus 100 having the structure explained above, the top of the lengthy plastic film F wound around a prescribed roll (not shown) is fed to the surface of the conveyer belt 3 through plural conveyer rolls (not shown). Then, when the drive rolls 1 and 2 are driven with rotation, the upper part of the conveyer belt 3 is moved in the direction shown by the arrow in FIG. 1 and along with this, the plastic film F is also conveyed together with the conveyer belt 3 with the result that the plastic film F is rubbed by the rubbing roll 4.

Here, the rubbing strength RS defined by the following equation (1) is characterized to set to 2600 mm or more (preferably 3400 mm or more) in the rubbing treatment step according to this embodiment.

RS=N·M(1+2πr·nr/v) (1)

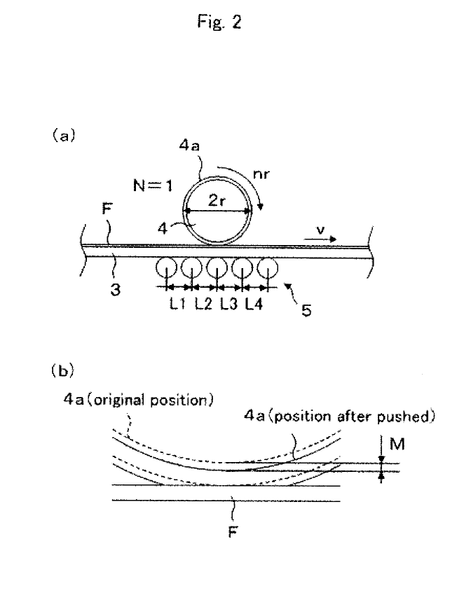

FIG. 2 is a front view partially showing the rubbing treatment apparatus 100 shown in FIG. 1, wherein FIG. 2(a) is a front view of the vicinity of a rubbing roll 4 and FIG. 2(b) is an enlarged front view showing the vicinity of contact places of a rubbing roll 4 with the surface of a plastic film F. As shown in FIG. 2, in the above equation (1), N represents the number of rubbings (corresponding to the number of rubbing rolls 4, 1 in this embodiment) (dimensionless number), M represents the pushing amount (mm) of the rubbing roll 4, π represents the ratio of circumference, r represents of the radius (mm) of the rubbing roll (including a raised fabric 4a), nr represents the number of rotations (rpm) of the rubbing roll 4 and v represents a conveying speed (mm/min) of the plastic film F. In this case, the term “pushing amount M of the rubbing roll” means the shift (shift of the rubbing roll 4 pushed up to the position shown by the solid line in FIG. 2(b)) of the rubbing roll 4 pushed to the plastic film F from the original position provided that when the position of the rubbing roll 4 is varied with respect to the surface of the plastic film F, the position (position shown by the dotted line in FIG. 2(b)) at which the hair tip of the raised fabric 4a wound around the rubbing roll 4 is first brought into contact with the surface of the plastic film F is the original position (0 point).

When the rubbing strength RS is set to 2600 mm or more, as mentioned above, uniform orientation characteristics can be imparted to the plastic film even if the plastic film F gives rise to blocking and hence, an optical film having uniform optical characteristics can be obtained. Any material may be used as the plastic film F to be applied in the production method according to this embodiment without any particular limitation insofar as it has the ability to orientate liquid crystalline molecules applied to the surface of the plastic film as will be described later by rubbing the surface or the orientated film formed on the surface.

Examples of the plastic film F may include films made of polyolefins such as triacetyl cellulose (TAC), polyethylene, polypropylene and poly(4-methylpentene-1), polyimides, polyimideamides, poly ether imides, polyamides, polyether ether ketones, polyether ketones, polyketone sulfides, polyether sulfones, polysulfones, polyphenylene sulfides, polyphenylene oxides, polyethylene terephthalates, polybutylene terephthalates, polyethylene naphthalates, polyacetals, polycarbonates, polyallylates, acryl resins, polyvinyl alcohols, polypropylene, cellulose type plastics, epoxy resins or phenol resins. Also, laminates obtained by laminating, as an orientated film, for example, a birefringent stretched film processed by stretching treatment such as uniaxial stretching on the above films may also be used as the plastic film F.

However, the production method according to this embodiment is particularly effective for films, for example, triacetyl cellulose films, which easily give rise to blocking. Triacetyl films are preferably saponified to prevent the occurrence of the phenomenon that a layer of liquid crystalline molecules fixed to the surface of the film is broken when the optical film produced by the production method according to this embodiment is wound roll-wise.

Though each parameter may be optionally selected as long as the rubbing strength RS is set to 2600 mm or more, in view of the specification of the apparatus, generally, each parameter is selected from combinations of each parameter falling in the following ranges to obtain a rubbing strength RS of 2600 mm or more: the conveying speed v of the plastic film F is in a range from 1 to 50 m/min and preferably 1 to 10 m/min, the number of rotations nr of the rubbing roll 4 is in a range from 1 to 3000 rpm and preferably 500 to 2000 rpm and the pushing amount M of the rubbing roll 4 is in a range from 100 to 2000 μm and preferably 100 to 1000 μm.

Liquid crystalline molecules are applied to the surface of the plastic film F which has been rubbed in the above manner and then the applied liquid crystalline molecules are cured and solidified to produce an optical film.

When the liquid crystalline molecules are applied, generally, a solution in which a liquid crystal compound is dissolved is used. As the liquid crystalline molecules to be contained in the solution, a liquid crystal polymer, a liquid crystal prepolymer, a liquid crystal monomer or the like is properly used.

When a liquid crystal polymer is used, a liquid crystal polymer solution is applied to the surface of the plastic film F, heated to a temperature above the temperature range where the liquid crystal polymer exhibits a liquid crystal phase, dried and then cooled rapidly to ambient temperature while keeping a state exhibiting the liquid crystal phase, whereby it is possible to fix the liquid crystal state exhibiting optical anisotropy.

When a liquid crystal prepolymer or a liquid crystal monomer is used, a solution containing each of these compounds is applied to the surface of the plastic film F, heated to a temperature above the temperature range where the liquid crystal prepolymer or the liquid crystal polymer exhibits a liquid crystal phase, dried, then cooled rapidly to a temperature at which the liquid crystal prepolymer or the liquid crystal polymer exhibits a liquid crystal phase and exposed to ultraviolet light or the like to crosslink it, whereby it is possible to fix the liquid crystal state exhibiting optical anisotropy.

As the above liquid crystal monomer, an appropriate monomer may be selected from monomers represented by the following chemical formulae (2) to (17).

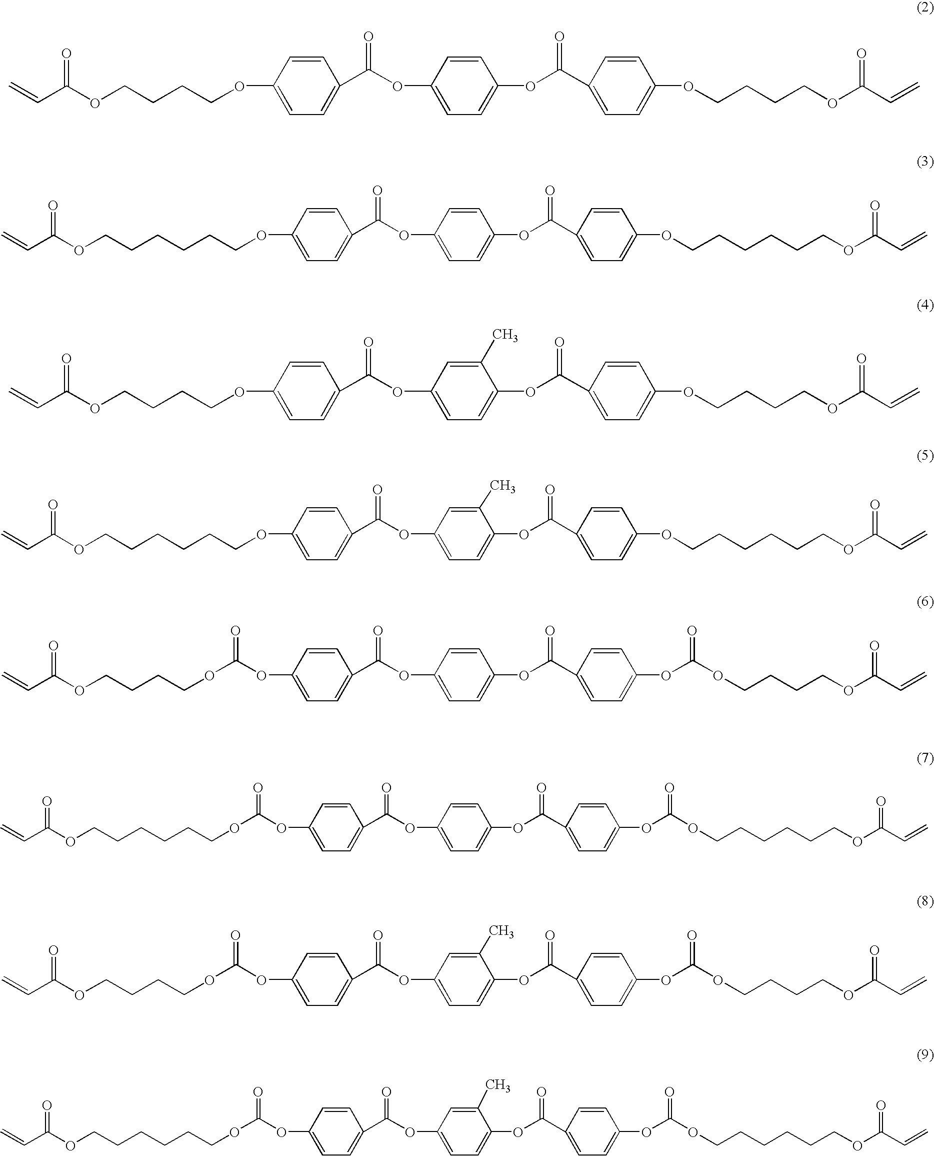

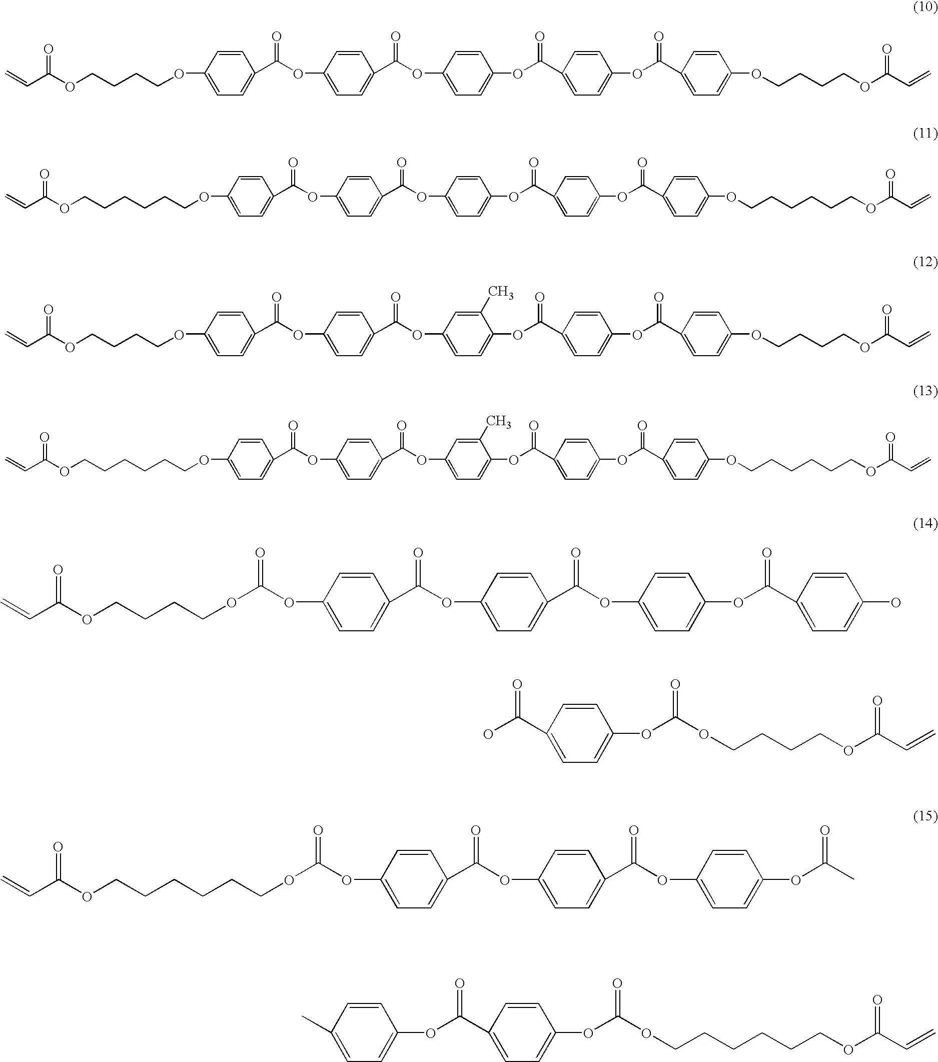

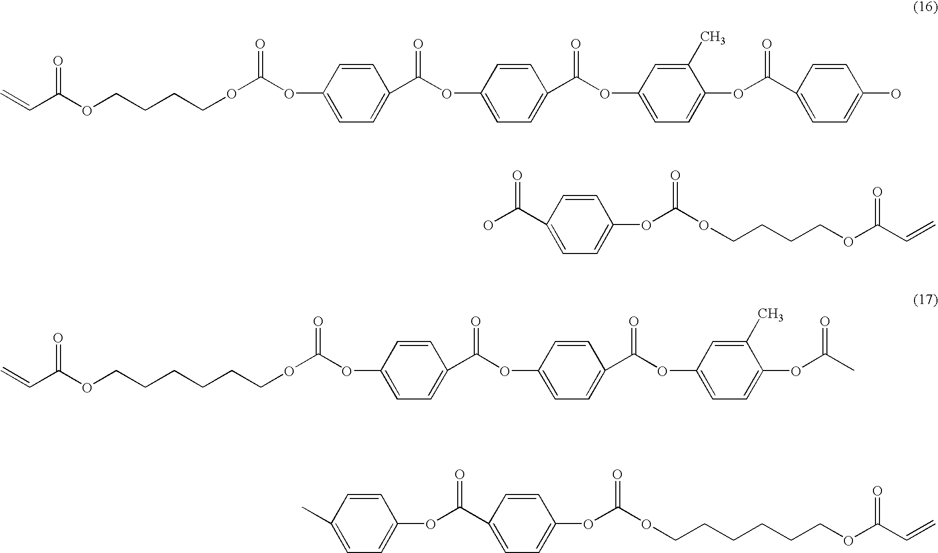

Then, the liquid crystal monomer solution preferably contains a polymerizing agent and a crosslinking agent. As these polymerizing agent and crosslinking agent, for example, those mentioned below may be used, though no particular limitation is imposed on it. As the polymerizing agent, for example, benzoyl peroxide (BPO), azobisisobutyronitrile (AIBN) or the like may be used. As the crosslinking agent, for example, an isocyanate type crosslinking agent, epoxy type crosslinking agent or metal chelate crosslinking agent may be used. These compounds may be used either singly or in combinations of two or more.

A coating solution which is a liquid crystal monomer solution may be prepared, for example, by dissolving and dispersing the above liquid crystal monomer in an adequate solvent. As the foregoing solvent, for example, halogenated hydrocarbons such as chloroform, dichloromethane, carbon tetrachloride, dichloroethane, tetrachloroethane, methylene chloride, trichloroethylene, tetrachloroethylene, chlorobenzene and orthodichlorobenzene, phenols such as phenol, p-chlorophenol, o-chlorophenol, m-cresol, o-cresol and p-cresol, aromatic hydrocarbons such as benzene, toluene, xylene, methoxybenzene and 1,2-dimethoxybenzene, ketone type solvents such as acetone, methyl ethyl ketone (MEK), methyl isobutyl ketone, cyclohexanone, cyclopentanone, 2-pyrrolidone and N-methyl-2-pyrrolidone, ester type solvents such as ethyl acetate and butyl acetate, alcohol type solvents such as t-butyl alcohol, glycerin, ethylene glycol, triethylene glycol, ethylene glycol monomethyl ether, diethylene glycol dimethyl ether, propylene glycol, dipropylene glycol and 2-methyl-2,4-pentanediol, amide type solvents such as dimethylformamide and dimethylacetamide, nitrile type solvents such as acetonitrile and butyronitrile, ether type solvents such as diethyl ether, dibutyl ether, tetrahydrofuran and dioxane or carbon disulfide, ethyl cellosolve, butyl cellosolve and the like may be used though no particular limitation is imposed on it. Among these solvents, toluene, xylene, mesitylene, MEK, methyl isobutyl ketone, cyclohexanone, ethyl cellosolve, butyl cellosolve, ethyl acetate, butyl acetate, propyl acetate and ethyl acetate cellosolve are preferable. These solvents may be used either singly or in combinations of two or more.

The above coating solution may be fluid-developed by a conventionally known method such as a roll coating method, spin coating method, wire bar coating method, dip coating method, extrusion coating method, curtain coating method or spray coating method. Among these methods, spin coating method or extrusion coating method is preferable from the viewpoint of coating efficiency.

The temperature condition of the heat treatment carried out after the liquid crystal monomer coating solution is applied to the surface of the plastic film F is usually in a range from 40 to 120° C., preferably in a range from 50 to 100° C. and more preferably in a range from 60 to 90° C. though it may be determined optionally according to the type of liquid crystal monomer to be used, for example, and specifically, according to a temperature at which the liquid crystal monomer exhibits liquid crystallinity. If the above temperature is 40° C. or more, the liquid crystal monomer can be generally sufficiently orientated whereas if the above temperature is 120° C. or less, the range of choice of the plastic film F is resultantly widened in view of heat resistance, for example.

As the above liquid crystal compound to be dissolved, for example, a bar-like liquid crystal compound, flat liquid crystal compound or a polymer of these compounds is used though no particular limitation is imposed on it as long as it can be coated. More specifically, liquid crystal compounds such as azomethines, azoxies, cyanobiphenyls, cyanophenyl esters, benzoates, phenyl cyclohexanecarboxylates, cyanophenylcyclohexanes, cyano-substituted phenylpyrimidines, alkoxy-substituted phenylpyrimidines, phenyldioxanes, tolans and alkenylcyclohexylbenzonitriles and polymers of these compounds are preferably used.

The optical film produced by the production method according to this embodiment mentioned above may be provided with functions such as retardation, chromatic compensation, enlargement of angle of vision and antireflection by appropriately applying known methods and may be used as optical films of various display devices such as a liquid crystal display, a plasma display and an EL display.

In a preferred structure of this embodiment, the plural backup rolls 5 disposed almost parallel to each other are so designed that the interval (L1-L4 in FIG. 2) between the axes of adjacent backup rolls 5 is 50 mm or more and 90 mm or less (more preferably 60 mm or more and 80 mm or less).

Such a structure makes it easy to improve the flatness of the conveyer belt 3 supported by the backup rolls 5. Also, since the interval L1-L4 between axes is set to 50 mm or more (this inevitably increases the outside diameter of the backup roll), the backup roll 5 does not rotate at a high speed in the rubbing treatment, and therefore, the problem that, for example, the plastic film F supported by the conveyer belt 3 is deformed by the heat generated at this time does not easily arise. Moreover, since the interval L1-L4 between axes is set to 90 mm or less, the flatness of the conveyer belt 3 is not dropped but uniform orientation characteristics can be imparted to the plastic film F.

The outside diameter of each backup roll 5 is preferably set to 30 mm or more and 80 mm or less (more preferably 40 mm or more and 70 mm or less). When the outside diameter of the backup roll 5 is set to 30 mm or more, the backup roll 5 does not rotate at a high speed in the rubbing treatment, and therefore, the problem that, for example, the plastic film F supported by the conveyer belt 3 is deformed by the heat generated at this time does not easily arise. Moreover, when the outside diameter of the backup roll is set to 80 mm or less, the flatness of the conveyer belt 3 is not dropped but uniform orientation characteristics can be imparted to the plastic film F.

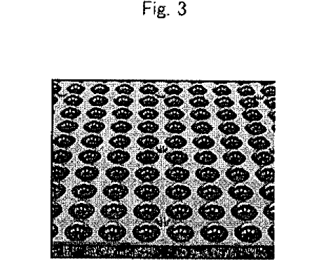

In this embodiment, explanations are described taking the case where the backup roll 5 is a bar-like roll as an example. However, the present invention is not limited this case and a plate (bearing plate) with plural spherical bodies may be applied as the backup roll as shown in FIG. 3.

The characteristic of the present invention will be mentioned more clearly by way of examples and comparative examples.

First, in the following Examples 1-1 to 1-3 and Comparative Example 1, the pushing amount of the rubbing roll in the rubbing treatment was altered in each case to manufacture retardation films. Detailed explanations will be given below.

### EXAMPLE 1-1

### (1) Rubbing Treatment

A rubbing treatment apparatus 100 shown in FIG. 1 and FIG. 2 was used to give rubbing treatment to the surface of a 40 μm-thick saponified triacetyl cellulose film. The mirror finished surface of the conveyer belt 3 had Ra=0.01 μm, the outside diameters of the drive rolls 1 and 2 were respectively 550 mm, the conveying speed of the film was 5 m/min and the intervals L1-L4 between the axes of adjacent backup rolls 5 were all 80 mm. Also, the radius of the rubbing roll 4 (including a raised fabric 4a) was 76.89 mm and a raised fabric made of rayon was wound as the rubbing roll 4 upon use. The rotating axis of the rubbing roll 4 was slanted at an angle of 24.3° with respect to the conveying direction of the film, the number of rotations of the rubbing roll 4 was 1500 rpm and the pushing amount was 0.3 mm. The rubbing strength in this condition was 2609 mm.

### (2) Preparation of a Coating Solution Containing a Liquid Crystal Compound

0.03 g of an optical polymerization initiator (trade name: Irgacure 907, manufactured by Ciba Specialty Chemicals Inc.) was added to 1 g of an ultraviolet-polymerizable nematic liquid crystal compound represented by the following chemical formula and the mixture was diluted with toluene such that the solid content was 20% by weight. The mixture was then stirred for 10 minutes to obtain a coating solution.

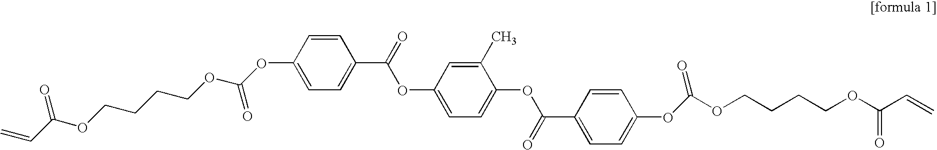

### (3) Application and Fixing of Liquid Crystalline Molecules

The above coating solution was applied to the rubbed surface of the above triacetyl cellulose film by using a cap coater, dried at 90° C. for 2 minutes, cooled to ambient temperature, irradiated with ultraviolet light at an integrated dose of 100 mJ/cm² to cure the liquid crystalline molecules, thereby manufacturing a retardation film.

### EXAMPLE 1-2

A retardation film was manufactured according to Example 1-1 except that the pushing amount of the rubbing roll 4 was set to 0.4 mm (the rubbing strength at this time was 3479 mm).

### EXAMPLE 1-3

A retardation film was manufactured according to Example 1-1 except that the pushing amount of the rubbing roll 4 was set to 0.5 mm (the rubbing strength at this time was 4349 mm).

### COMPARATIVE EXAMPLE 1

A retardation film was manufactured according to Example 1-1 except that the pushing amount of the rubbing roll 4 was set to 0.2 mm (the rubbing strength at this time was 1739 mm).

### <Results of Evaluation>

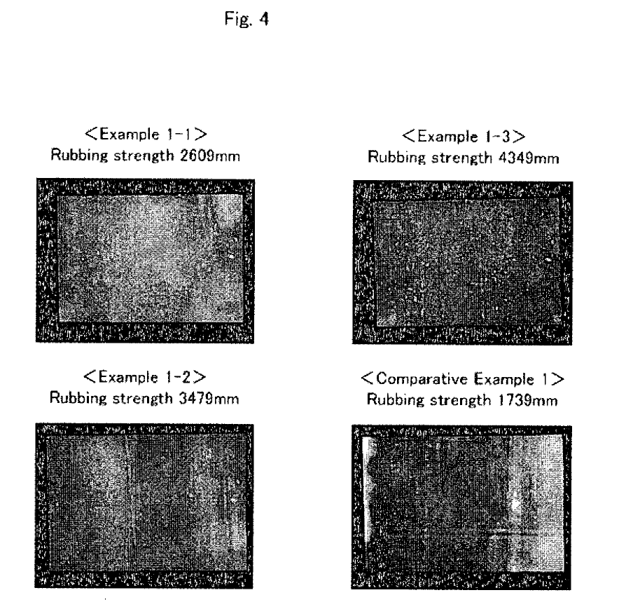

FIG. 4 shows visual photographs of the retardation films manufactured in Examples 1-1 to 1-3 and Comparative Example 1. The visual photograph was taken in the condition that each retardation film was sandwiched between two polarizing plates disposed such that their absorption axes were perpendicular to each other and these two polarizing plates and the retardation film were laminated such that the absorption axis of the visual side (imaging side) polarizing plate is parallel to the slow axis of the retardation film. As shown in FIG. 4, it was found that each retardation film manufactured in Examples 1-1 and 1-3 by carrying out rubbing treatment in the condition that the rubbing strength was 2600 mm or more was observed to have uniform orientation state (particularly, the retardation films obtained in Examples 1-2 and 1-3 made to have a rubbing strength of 3400 mm or more had highly uniform orientation state), whereas the retardation film of Comparative Example 1 manufactured by carrying out rubbing treatment in the condition that the rubbing strength was less than 2600 mm had ununiform orientation state and was uneven.

Then, in the following Examples 2-1 and 2-2 and Comparative Examples 2-1 and 2-2, the number of rotations of the rubbing roll in the rubbing treatment was changed in each example to manufacture retardation films. Detailed explanations will be explained below.

### EXAMPLE 2-1

A retardation film was produced according to Example 1-1 (the number of rotations of the rubbing roll: 1500 rpm) except that the pushing amount of the rubbing roll 4 was set to 0.4 mm (the rubbing strength at this time: 3479 mm) (specifically, a retardation film was manufactured in the same condition as in Example 1-2).

### EXAMPLE 2-2

A retardation film was produced according to Example 1-1 except that the number of rotations of the rubbing roll 4 was changed to 2000 rpm and the pushing amount of the rubbing roll 4 was set to 0.4 mm (the rubbing strength at this time: 4638 mm).

### COMPARATIVE EXAMPLE 2-1

A retardation film was produced according to Example 1-1 except that the number of rotations of the rubbing roll 4 was changed to 500 rpm and the pushing amount of the rubbing roll 4 was set to 0.4 mm (the rubbing strength at this time: 1160 mm).

### COMPARATIVE EXAMPLE 2-2

A retardation film was produced according to Example 1-1 except that the number of rotations of the rubbing roll 4 was changed to 1000 rpm and the pushing amount of the rubbing roll 4 was set to 0.4 mm (the rubbing strength at this time: 2319 mm).

### <Results of Evaluation>

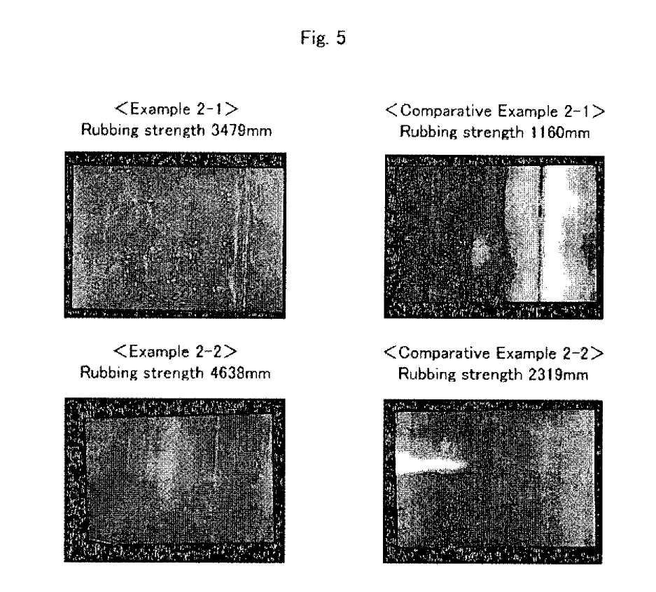

FIG. 5 shows visual photographs of retardation films manufactured in Examples 2-1 and 2-2 and Comparative Examples 2-1 and 2-2. As shown in FIG. 5, it was found that each retardation film manufactured in Examples 2-1 and 2-2 by carrying out rubbing treatment in the condition that the rubbing strength was 2600 mm or more was observed to have uniform orientation state, whereas each retardation film of Comparative Examples 2-1 and 2-2 manufactured by carrying out rubbing treatment in the condition that the rubbing strength was less than 2600 mm had ununiform orientation state and was uneven.

### EXAMPLE 3-1

Rubbing treatment was given to a 40 μm-thick saponified triacetyl cellulose film according to Example 1-1 except that the interval between the axes of the backup rolls 5 was set to 70 mm and the rubbing strength was set to 3479 mm.

### EXAMPLE 3-2

Rubbing treatment was carried out according to Example 3-1 except that the interval between the axes of the backup rolls 5 was set to 90 mm.

### EXAMPLE 3-3

Rubbing treatment was carried out according to Example 3-1 except that the interval between the axes of the backup rolls 5 was set to 110 mm.

### <Results of Evaluation>

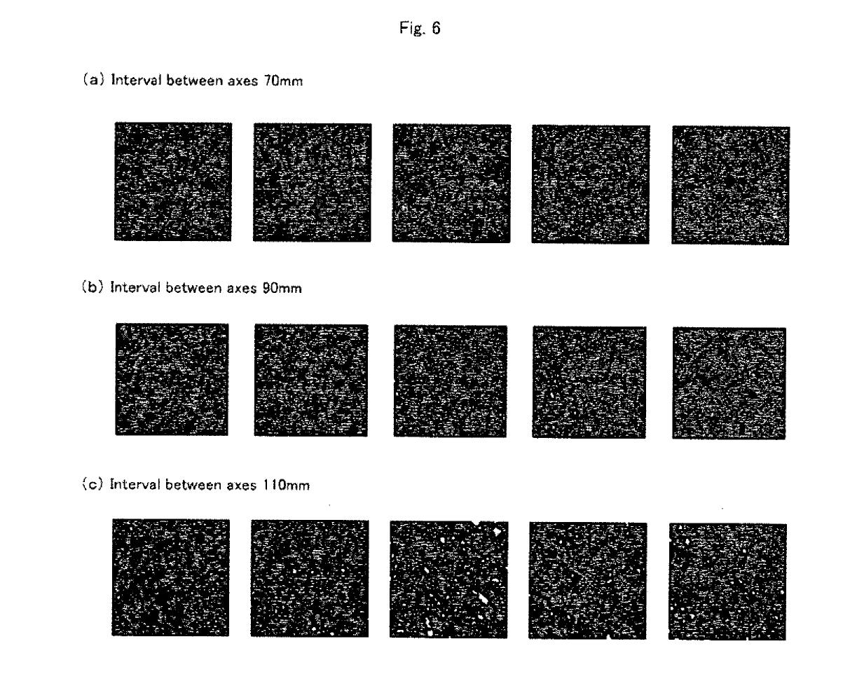

FIG. 6 shows visual photographs of triacetyl cellulose films to which rubbing treatment was given in Examples 3-1 to 3-3. More specifically, the visual photograph shown in FIG. 6 shows an image obtained by picking up an image of the triacetyl cellulose film to which rubbing treatment was given, by using a laser microscope (model: VK-8500, manufactured by KEYENCE Corporation) and by binary-digitizing the picked-up images (white-black shaded image with 256 gradations) at the same binary-digitized level (151st or more gradations were white, and 150th or less gradations were black in 256 gradations) using an image processing soft “adobe photoshop”. It is to be noted that each visual photograph shown in FIG. 6 is a binary-digitized image at each position 50 mm, 210 mm, 370 mm, 530 mm and 690 mm distant from the end in the direction of width of the triacetyl cellulose film in the order from the left side on the image.

With regard to the films according to Examples 3-1 and 3-2 shown in FIG. 6, the area of white points (corresponding to foreign matter stuck to the film) extracted by binary digitization was decreased. This is supposed because the orientation characteristics of the films according to Examples 3-1 and 3-2 are uniform, which is the cause of a reduction in sticking of foreign matter. With regard to the film according to Example 3-3, on the other hand, the area of white points is larger than that of each film obtained in Examples 3-1 and 3-2. However, this is practically no problematic level.

1. A method for producing an optical film, the method comprising a rubbing treatment step of rubbing the surface of a lengthy plastic film with a rubbing roll obtained by winding a raised fabric, an application step of applying a liquid crystalline molecule to the surface of the plastic film processed through said rubbing treatment step and a fixing step of fixing said applied liquid crystalline molecule, wherein:
in said rubbing treatment step, said lengthy plastic film is supported and conveyed by a conveyer belt having a metal surface, and plural backup rolls which support the underside of the conveyer belt supporting said plastic film are disposed opposite to said rubbing roll, to set a rubbing strength RS defined by the following equation (1) to 2600 mm or more:
RS=N·M(1+2πr·nr/v) (1)
wherein N represents the number of rubbings (the number of rubbing rolls) (dimensionless number), M represents the pushing amount of the rubbing roll (mm), π represents the ratio of circumference, r represents the radius (mm) of the rubbing roll (including a raised fabric), nr represents the number of rotations (rpm) of the rubbing roll and v represents a conveying speed (mm/sec) of the plastic film.

2. The method for producing an optical film according to claim 1, wherein said plural backup rolls are plural bar-like backup rolls arranged in almost parallel to each other and the interval between the axes of adjacent backup rolls is set to 50 mm or more and 90 mm or less.

3. The method for producing an optical film according to claim 2, wherein the outside diameter of said backup roll is set to 30 mm or more and 80 mm or less.

4. The method for producing an optical film according to claim 1, wherein said plastic film is a triacetyl cellulose film.

5. The method for producing an optical film according to claim 4, wherein said triacetyl cellulose film is saponified.

6. The method for producing an optical film according to claim 1, wherein said raised fabric is any one of rayon, cotton and mixtures of these materials.

7. The method for producing an optical film according to claim 1, wherein the thickness of said conveyer belt is 0.5 mm or more and 2.0 mm or less.
